(19) United States
(12) Patent Application Publication
(10) Pub. No.: US 2015/0100440 A1
(43) Pub. Date: Apr. 9, 2015

(54) Methods and Systems Related to a Payment Kiosk

(71) Applicant: Abe Rubin, Cuidad de Panama (PA)

(72) Inventor: Abe Rubin, Cuidad de Panama (PA)

(21) Appl. No.: 14/047,136

(22) Filed: Oct. 7, 2013

(51) Int. Cl. G06Q 20/18; G06Q 20/32

(52) U.S. Cl. CPC G06Q 20/18; G06Q 20/322
USPC 705/16

(57) ABSTRACT

Payment kiosk. At least some of the illustrative embodiments are methods including: obtaining information about a cash payment for services, the obtaining by a kiosk; receiving the cash payment from a user, the receiving by the kiosk; sending a request to a service provider of the services, the request to pay for services, and the sending from the kiosk to the service provider by way of a portable electronic device carried by the user; receiving, by the kiosk, a notification of approval from the service provider, the receiving by the kiosk through the portable electronic device; and receiving an indication of receipt related to the payment, the receiving by the portable electronic device.

### BACKGROUND

A user may wish to purchase services, or pay for services, from a remote service provider. For example, a user may wish to purchase communication services for a portable electronic device, such as additional voice time and/or data services, from a cellular provider. However, in some cases, services may not be purchased with credit, and thus a user may need to make a cash payment. It may be inconvenient to purchase services at a brick-and-mortar location of the service provider, and thus other means of purchasing services with cash would be advantageous.

### BRIEF DESCRIPTION OF THE DRAWINGS

For a detailed description of exemplary embodiments, reference will now be made to the accompanying drawings in which:

FIG. 1 shows a system in accordance with at least some embodiments;

FIG. 2 shows, in perspective view, an example kiosk in accordance with at least some embodiments;

FIG. 3 shows, in block diagram form, a system in accordance with at least some embodiments;

FIG. 4A shows an example screenshot of a service purchasing program in accordance with at least some embodiments;

FIG. 4B shows an example screenshot of a service purchasing program in accordance with at least some embodiments;

FIG. 4C shows an example screenshot of a service purchasing program in accordance with at least some embodiments;

FIG. 5 shows an example interaction between a kiosk and two users in accordance with at least some embodiments;

FIG. 6 shows a computer system in accordance with at least some embodiments; and

FIG. 7 shows, in block diagram form, a method in accordance with at least some embodiments.

### NOTATION AND NOMENCLATURE

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

“Cellular network” shall mean a plurality of fixed location transceiver stations that, when operated together by a cellular carrier, provide cellular services to portable electronic devices.

“Cellular carrier” shall mean an entity operating a cellular network providing cellular services.

“Cellular service” or “cellular services” shall mean wireless voice services, wireless data services, and/or wireless message services (e.g., text messages).

“Wireless communication protocol” shall mean a communication protocol where two devices communicate by way of electromagnetic waves propagating through the air (e.g., Zigbee, Bluetooth, IEEE 802.11). A cellular network shall not be considered a “wireless network protocol.”

“Remote” shall mean one kilometer or more.

“Proximity” shall mean within three meters.

“Airtime services” shall mean wireless voice services.

“Data services” shall mean wireless data services and/or wireless message services (e.g., short message services).

“Banknotes” shall mean physical, non-coin, currency.

“Portable electronic device” shall mean any device which is portable and/or wearable, which includes both short-range and long-range wireless communication capabilities.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are directed to systems and methods of purchasing services from a remote service provider at a kiosk with a cash payment. In particular, a portable electronic device communicates with a kiosk in order to enable a user to pay for services with a cash payment deposited into the kiosk. Communications between the kiosk and the service provider (e.g., a cellular carrier) are enabled by way of communication through the portable electronic device. The specification first turns to a high level overview of an example embodiment of purchasing cellular services.

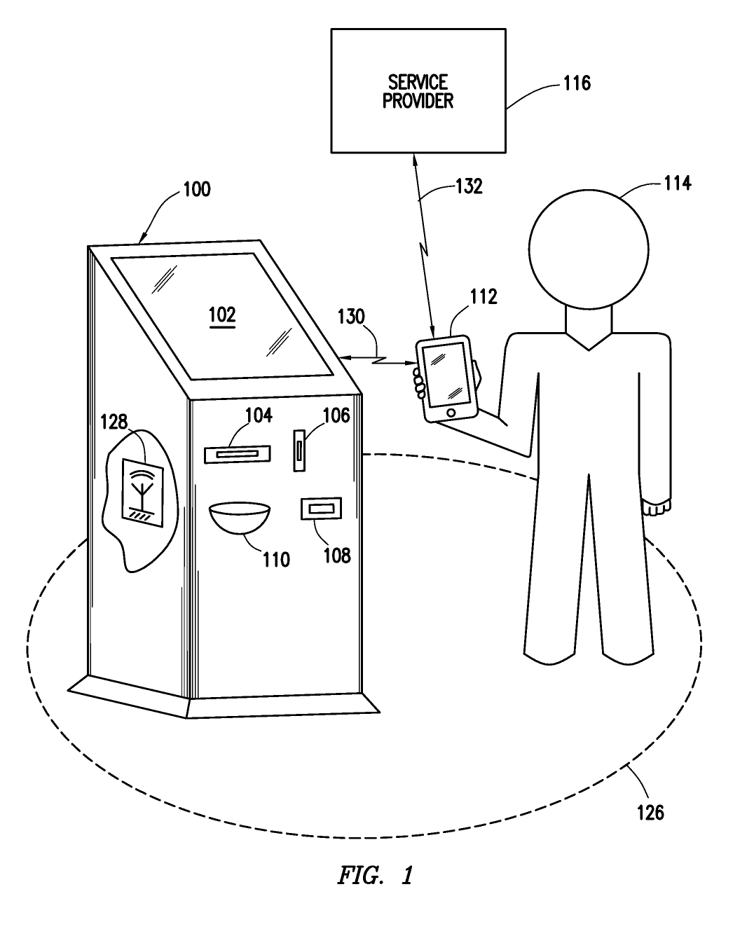

FIG. 1 shows an example high level embodiment. In particular, FIG. 1 shows a user 114 within proximity range (shown by dotted line 126) of a kiosk 100. The kiosk 100 executes software running on a computer system within the kiosk which enables the user 114 to purchase and to receive services wirelessly. For example, user 114 may deposit money into the kiosk 100 in order to purchase additional airtime or data services for the user's portable electronic device.

In interacting with kiosk 100, the user 114 may be any person with physical and operational control over a portable electronic device 112. In one embodiment, the portable electronic device 112 may be any type of portable electronic device having wireless communication capabilities, such as a cellular telephone, a personal digital assistant (“PDA”), a tablet computer, a smartphone, a smart watch, or head mounted computer system.

The portable electronic device 112 communicates both with kiosk 100 and also with a remote computer system operating at a service provider 116. In one embodiment, the wireless communications 132 between the portable electronic device 112 and the service provider 116 may take place over a cellular network. For example, the communications 132 between the portable electronic device 112 and the service provider 116 may be by way of data services on the cellular network (e.g., text messaging, internet protocol (IP) connections).

In addition to communications 132 with the service provider 116, portable electronic device 112 also communicates by way of wireless communications 130 with kiosk 100. The portable electronic device 112 and kiosk 100 may communicate by way of a wireless communications protocol, such as through the use of Bluetooth® technology (for example, by way of antenna 128), Zigbee, and/or IEEE 802.11.

In one embodiment, the service provider 116 may be a cellular carrier (e.g., AT&T, Movistar, or Virgin Mobile), and thus the service provider 116 may be a provider of cellular services, where the service provider 116 provides to the user 114 services such as wireless voice services, wireless data services, and/or wireless messaging services (e.g., text messages). The services capable of being purchased by the user 114, however, are not limited to cellular services. Rather, in another embodiment, service provider 116 may be a company providing services outside of the communications arena. For example, the user may use the described systems and methods to purchase services such as utility services (e.g., water or electricity), or to pay a bill for services already received.

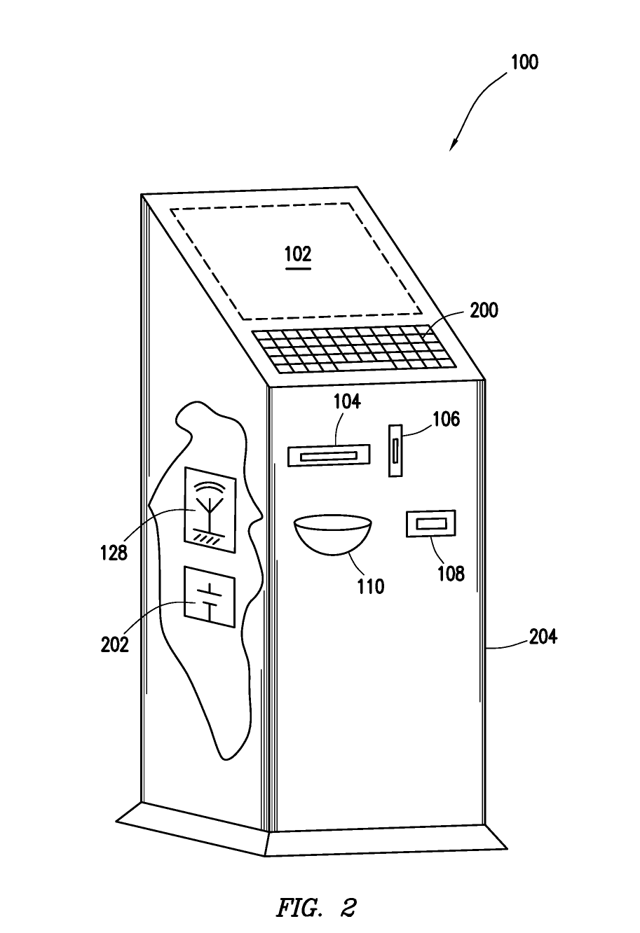

Before turning to a more detailed discussion regarding purchasing services at the kiosk, a more detailed discussion of the kiosk 100 is provided in reference to FIG. 2.

The Kiosk

FIG. 2 shows a perspective, partial cut-away, view of kiosk 100 in accordance with at least some embodiments. In particular, kiosk 100 may be a standalone structure comprising, in part, a computer system (not specifically shown) executing software to perform a plurality of functions. The outer housing 204 of the kiosk 100 may be comprised of a hard material, such as metal, plastic, or fiberglass. In another embodiment, kiosk 100 may not be a standalone structure, but may be integrated into another structure, such as a wall.

In addition, the kiosk 100 may comprise a display device 102 visible through the outer housing 204. In one embodiment, the display device 102 may be, for example, a Liquid Crystal Display (LCD) monitor with touchscreen capabilities. In particular, the touchscreen capabilities of display device 102 enable the user to interact directly with what is displayed on the display device in order to make selections and to provide information to the kiosk 100. The type of touchscreen is not limited to one technology, and as such may be any type of touchscreen; for example, a capacitive touchscreen or an infrared touchscreen. In another embodiment, the display device 102 may be a display device without touchscreen capabilities.

The kiosk 100 may comprise a keyboard 200 by which the user may input information. In one embodiment, the keyboard, which may be alphabetic, numeric and/or alphanumeric, may be part of the touchscreen display device 102 itself. For example, keystrokes on the keyboard may be made by touching “keys” displayed on the touchscreen. In another example embodiment, the keyboard 200 may be a physical keyboard located near the display device 102. In yet still another embodiment, the kiosk 100 may not comprise any type of display device, and user interactions with the kiosk 100 may be by way of interactions directly on the portable electronic device 112.

Still referring to FIG. 2, kiosk 100 may comprise an aperture 104 into which banknotes may be inserted for receipt by the kiosk. In addition to banknotes, kiosk 100 may comprise a second aperture 106 into which coins are inserted. In the event the user deposits more money than is needed for the services desired, the kiosk 100 may also have a change cup 110 into which change is dispensed. In addition to receiving (and in some cases returning) money, the kiosk may also provide a physical printout of an invoice or a receipt regarding the purchase of services. Thus, kiosk 100 may also comprise a printer 108.

In some embodiments, kiosk 100 may be located inside a building or near a building. For example, the kiosk 100 may be located at a gas station, within a retail outlet, or otherwise near a wall outlet, and thus the kiosk 100 may be powered by way of an electrical connection to the wall outlet (e.g., by way of an alternating current “AC”). In another embodiment, the kiosk 100 may be located outside or may not be located near a wall outlet. Thus, in embodiments where the kiosk 100 is not receiving power from a wall outlet, the kiosk 100 may be powered by a battery 202. In yet another embodiment, the battery 202 may be charged by way of solar power.

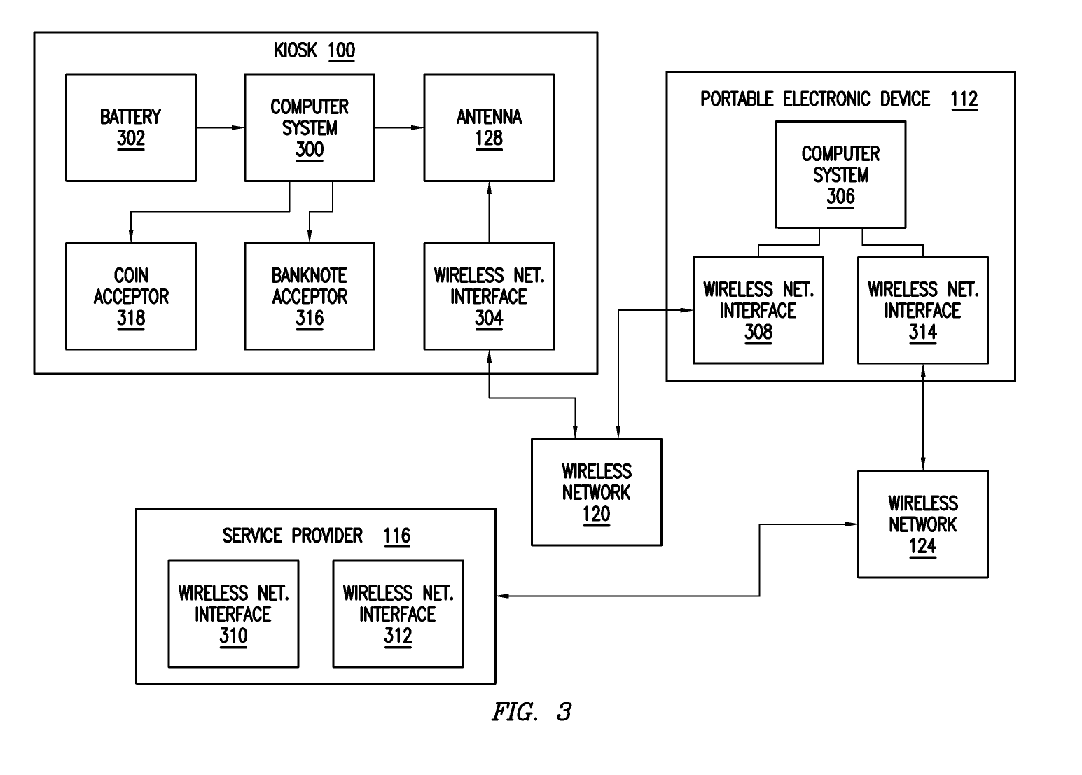

Furthermore, kiosk 100 may comprise an antenna 128 by which communications between the kiosk 100 and the portable electronic device 112 may be facilitated. A more detailed discussion regarding communications between the kiosk 100, the portable electronic device 112, and the service provider 116 follows with reference to FIG. 3.

Overall System

Communications Between Kiosk and Portable Electronic Device

FIG. 3 shows, in block diagram form, an overall system in accordance with at least some embodiments.

In particular, the system comprises a battery 302, which provides power to computer system 300 and wireless network interface 304. Kiosk 100 is communicatively coupled to portable electronic device 112 (e.g., a smartphone) by way of the wireless network interface 304 and over wireless network 120. In addition, kiosk 100 may comprise a banknote acceptor 316 and/or a coin acceptor 318. In one embodiment, when banknotes are deposited through aperture 104, the banknote acceptor 316 may communicate with the computer system 300 that banknotes have been deposited and confirm the amount of the deposit. Likewise, when coins are deposited through aperture 106, the coin acceptor 318 may communicate with the computer system 300 that coins have been deposited and confirm the amount of the deposit.

Still considering FIG. 3, portable electronic device 112 comprises a computer system 306, a wireless network interface 308, and a wireless network interface 314. Kiosk 100 and portable electronic device 112 may communicate wirelessly with each other by way of, in one example, wireless network interfaces 304 and 308, respectively. In particular, by way of wireless network interfaces 304 and 308, programs executed on the computer systems 300 and 306, respectively, may communicate with each other.

Referring still to FIG. 3, the illustrative wireless network interface 304 of the kiosk 100 may have a limited distance over which communication may take place. The range over which communication may take place need not extend beyond a proximity range surrounding kiosk 100 (e.g., proximity range 126 from FIG. 1). The protocol over which the wireless network interface 304 communicates may likewise take many forms. In one embodiment, the wireless network interface 304 implements a wireless communication protocol (i.e., radio frequency communication by way of electromagnetic waves propagating through the air). For example, the communication may be implemented by way of Zigbee network protocols, where the ZIGBEE® trademark is owned by Zigbee Alliance; a Bluetooth communication protocol; and/or an IEEE 802.11 compliant wireless connection. Wireless network interface 308 implements the same wireless communication protocol as wireless network interface 304.

In the specific example of Bluetooth communications, when the Bluetooth enabled devices come within a proximity range of one another, an electronic conversation takes place to determine whether the devices have data to share with one another. The electronic conversation happens automatically, and once the conversation has occurred, the devices form a wireless network.

The kiosk may communicatively scan within a proximity range in an attempt to find other Bluetooth devices with communication capabilities nearby. In one embodiment, the Bluetooth communication range for the kiosk may be within 3 meters. If a connection is made between the kiosk and a portable electronic device capable of making the Bluetooth connection comes within the proximity range 126, the kiosk will communicatively link up with the portable electronic device 112.

Communications Between Smart Phone and Service Provider

Referring still to FIG. 3, portable electronic device 112 is also communicatively coupled to a service provider 116 by way of wireless network 124. Service provider 116 may be any type of service provider; for example, a cellular carrier providing cellular services. Service provider 116 may be located remotely with respect to both the kiosk 100 and the portable electronic device 112. Service provider 116 comprises computer system 310 coupled to a wireless network interface 312.

Wireless network interface 314 of portable electronic device 112 communicates via wireless network 124 with service provider 116. In this example, wireless network 124 may be any conventional cellular network, 3G network, 4G network, or pager network for transmitting information between portable electronic device 112 and service provider 116.

It should be noted that the wireless network 120 (i.e., the network over which the kiosk 100 and portable electronic device 112 wirelessly communicate) is distinct from, and different than, the wireless network 124 (i.e., the network over which the portable electronic device 112 and service provider 116 wireless communicate).

Purchasing Services

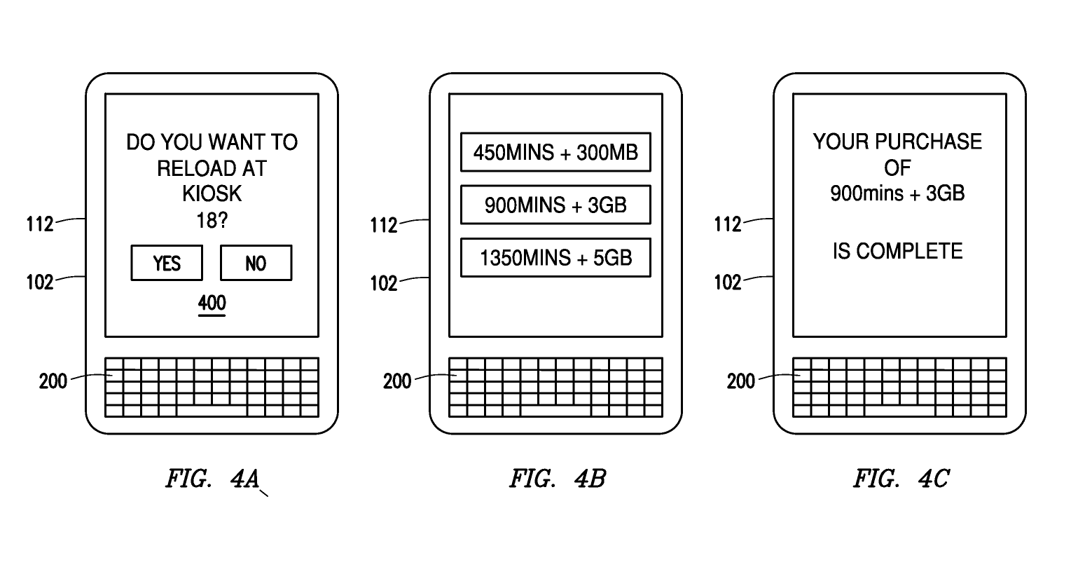

The specification next turns to a discussion of purchasing services using a portable electronic device and a kiosk, and refers to both FIG. 1 and FIG. 4.

On Kiosk

Returning again to FIG. 1, in one embodiment, a user 114 approaches kiosk 100. Once user 114 is within range 126 of the kiosk 100, the kiosk 100 and portable electronic device 112 establish a communication 130 with one another. In particular, the computer system of kiosk 100 may recognize and identify the portable electronic device 112. In identifying the portable electronic device 112, the kiosk 100 may determine identifying information such as the telephone number associated with the portable electronic device, the service provider associated with the portable electronic device 112, and/or the user associated with the portable electronic device account.

In one embodiment, the user 114 then interacts with the display device 102 of kiosk 100. Turning now to FIG. 4A, the kiosk 100 may display a first screen on display device 102 asking the user to confirm whether the user wants to purchase services at kiosk 100 for the portable electronic device 112. If the display device 102 is a touchscreen, the user can select the desired option on the display device. In another embodiment, if the display is not a touchscreen, the user can select the desired option using the keyboard 200. In yet another embodiment, selections and inputs may be made on the portable electronic devices, as previous discussed before.

The kiosk may then query the user on what services the user wants to purchase, as shown in FIG. 4B. In one embodiment, the purchase options may be specific communication options such as a specific amount of airtime and/or a specific amount of data. In another example embodiment, shown in FIG. 4B, the purchase options may be a service plan (e.g., a combination of airtime and data services). In yet another embodiment, the purchase options may be from a selection of preset monetary amounts. In yet still another embodiment, the purchase may not be for communication services at all, and thus another array of options may be presented to the user for selection. Once the user makes a selection, the kiosk 100 communicates with the service provider 116 through a communication with the portable electronic device 112. In other words, the kiosk 100 communicates with the portable electronic device 112 over wireless network 120. The portable electronic device then communicates with the service provider 116 over wireless network 124.

The service provider 116, in turn, provides a notification of approval or a notification denying the ability to make the purchase to the portable electronic device 112. In turn, the portable electronic device 112 communicates with the kiosk 100 indicating approval or disapproval from the service provider 116. If the portable electronic device 112 has received a notification of approval from the service provider 116, the user 114 will deposit an amount of cash into the kiosk, using aperture 104 and/or aperture 106. The money may be banknotes and/or coins. The computer system of the kiosk 100 receives notification of the cash payment and communicates with the portable electronic device 112 that payment has been received and that the user 114 has paid for the desired services. The kiosk 100 then causes the portable electronic device 112 to communicate with the service provider 116 to provide the payment information (e.g., the amount deposited). In the example embodiment of purchasing communication services for the portable electronic device 112, the service provider may then make available to the portable electronic device 112 the purchased airtime and/or data services upon notification of payment.

The portable electronic device 112 then communicates with the kiosk 100 that the service provider 116 has approved the transaction. The kiosk may then return an indication of a completed transaction on the display device as shown in FIG. 4C. In another embodiment, the kiosk, after receiving the notification of approval from the portable electronic device 112, may print a physical invoice or receipt. In yet another embodiment, the kiosk may trigger the sending of a receipt to the portable electronic device by way of a wireless communication, such as by way of a text message or an e-mail.

On Portable Electronic Device

In another embodiment, the user may provide information to and receive information from the kiosk 100 by way of the display device of the portable electronic device 112, instead of by way of the display device 102 of the kiosk 100. Returning again to FIG. 1, user 114 approaches kiosk 100. Once user 114 is within a specific proximity range 126 to the kiosk 100, the kiosk 100 and portable electronic device 112 establish a communication 130 with one another. As with the previous example embodiment, the computer system of kiosk 100 may recognize and identify the portable electronic device 112. In identifying the portable electronic device 112, the kiosk 100 may determine identifying information such as the telephone number associated with the portable electronic device, the service provider associated with the portable electronic device 112, and/or a user name associated with the portable electronic device account.

The user 114 activates application software on the portable electronic device 112, which enables the user to interact with kiosk 100. In one embodiment, the application software may be preloaded by the user onto the portable electronic device 112 before there is communication with the kiosk 100. In another embodiment, the portable electronic device 112 may be capable of wirelessly downloading the software application from the kiosk over wireless communication 130.

Once the portable electronic device 112 and kiosk 100 are communicatively linked, and the portable electronic device 112 is running the application (which may be triggered by the user, or may automatically be triggered when a communication connection is made by the kiosk 100), the user may use the portable electronic device to purchase services. Returning again to FIG. 4A, the first screen 400 displayed on the portable electronic device 112 may ask the user to confirm whether the user wants to purchase services at kiosk 100. By asking the user to confirm the desire to purchase services, the kiosk may be confirming that the information it has received from the portable electronic device regarding identification of the portable electronic device is indeed correct. For example, the first screen the user sees may be a confirmation sent by the kiosk to confirm that the telephone number and/or service provider associated with the portable electronic device is correct.

The user may interact with the kiosk by selecting options presented to the user on the portable electronic device display by way of a touchscreen keyboard, or by a physical keyboard on the portable electronic device. The portable electronic device 112 application will then query the user on what services the user wants to purchase, as shown in FIG. 4B. In one embodiment, the purchase options may be specific communication options such as a specific amount of airtime and/or a specific amount of data. In another embodiment, the purchase options may be a service plan (e.g., a combination of airtime and data services). In yet another embodiment, the purchase options may be from a selection of preset monetary amounts. In yet still another embodiment, the purchase may not be for communication services at all, and thus another array of options may be presented to the user for selection.

The portable electronic device 112 communicates with the service provider 116 to request the purchase of desired services. The service provider 116, in turn, provides a notification of approval or a notification denying the ability to make the purchase. If the portable electronic device 112 has received a notification of approval from the service provider 116, the portable electronic device 112 will communicate with kiosk 100 over wireless network 120 that approval has been given. Then, the user 114 will deposit an amount of cash into the kiosk, using aperture 104 and/or aperture 106. The money may be banknotes and/or coins.

The computer system of the kiosk 100 receives notification of the cash payment and communicates with the portable electronic device 112 that payment has been received and that the user 114 has paid for the desired services. The portable electronic device 112 communicates with the service provider 116 to request the purchased services be provided to the user and to communicate information regarding the payment made. In the example embodiment of purchasing services for the portable electronic device 112, the service provider may make available to the portable electronic device 112 the purchased airtime and/or data services upon notification of payment.

The portable electronic device 112 then communicates with the kiosk 100 that the service provider has approved the transaction. The kiosk may then return an indication of invoice or receipt to the portable electronic device, as shown in FIG. 4C. In another embodiment, the kiosk may, after receiving the notification of approval from the portable electronic device 112, print a physical invoice or receipt.

In the previous three example embodiments, the user may interact with either the display device 102 on kiosk 100, or by way of a software application executing on portable electronic device 112. It is possible, however, that the user may interact with both a display device 102 on the kiosk 100, and also by way of the software application on the portable electronic device 112. In other words, options may be presented on both display devices, and be mirrored on each one, such that selections and options chosen by and provided to the user are displayed on both.

Multiple Users

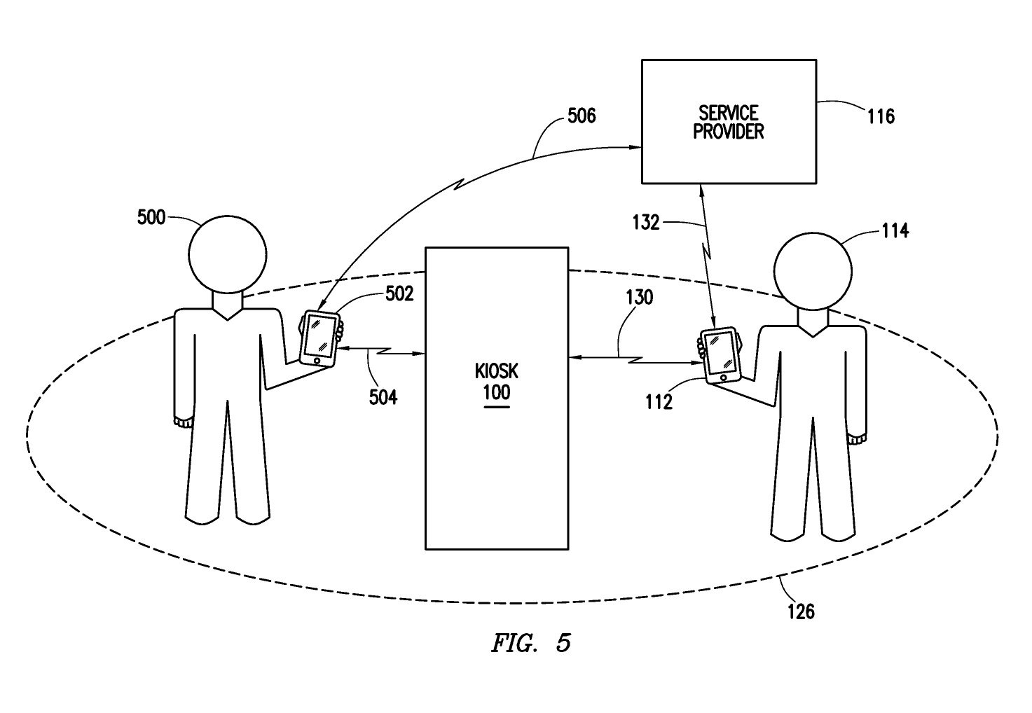

In another embodiment, multiple users may interact with the kiosk 100 and with one or more services providers at the same time. Turning now to FIG. 5, user 114 is within proximity range 126 of kiosk 100. Interactions between the user 114, the portable electronic device 112, and the service provider 116 may transpire as in the previously discussed embodiments. In addition, a second user 500 has entered within the proximity range 126 range of kiosk 100 during the time user 114 is interaction with the kiosk.

As with portable electronic device 112, kiosk 100 establishes a communication connection 504 with portable electronic device 502. Because it is possible for kiosk 100 to establish multiple communication connections with multiple devices, the communications 130 and 504 may be simultaneous. In another embodiment, however, the communications between the kiosk and multiple portable electronic devices may be subsequent to one another. In another embodiment, the communications may alternative between periods of waiting for and sending messages between the various devices.

For example, during the time user 114 is inserting cash into the kiosk, and communications are occurring between the kiosk 100 and the portable electronic device 112, and between the portable electronic device 112 and the service provider 116, the kiosk 100 may be communicating with portable electronic device 502 and user 500 to gather information. User 500 (and portable electronic device 502) may be placed in a “queue” such that when user 114 has completed the transaction, user 500 may already be partway through the interactions with the kiosk. In other words, by the time user 114 finishes the transaction, it is possible that the communications between the portable electronic device 502 and the kiosk 100 to confirm and identify the device and/or user, as well as to confirm the desired intentions of the user, have already been completed. Thus, when it is user 500's official “turn,” he can proceed directly to depositing money into the kiosk 100.

In order to ensure the correct subsequent user is depositing money for the correct transaction, a second confirmation may take place. The second confirmation may be by way of selecting the user's name or telephone number on either the display device 102 of the kiosk or by another confirmation on the portable electronic device 502, before the remaining portion of the transaction takes place.

The steps described above with respect to purchasing communication services for a portable electronic device are merely example steps and example services, and the embodiments are not limited to a portable electronic device. The steps, and the order in which they have been presented, are merely examples of the methods and systems described herein, and the breadth of the inventive concepts are not limited solely to these example embodiments. It is also noted that although the previous discussion has been in terms of a single service provider 116; the portable electronic device 112 may communicate with any of a number of service providers. Furthermore, the services purchased need not be communication services. In other words, the discussion has focused on a user purchasing air time and/or data services from a cellular service provider, but it is possible for the user to use the kiosk 100 to purchase any of a number of services. For example, payment or purchase for utility services such as water and electricity. In another example, communications between the kiosk 100 and the portable electronic device 112 may enable depositing money into other accounts, such as online auction accounts associated with the phone number, or an account with an electronic retailer associated with the phone number (e.g., Amazon, eBay, PayPal).

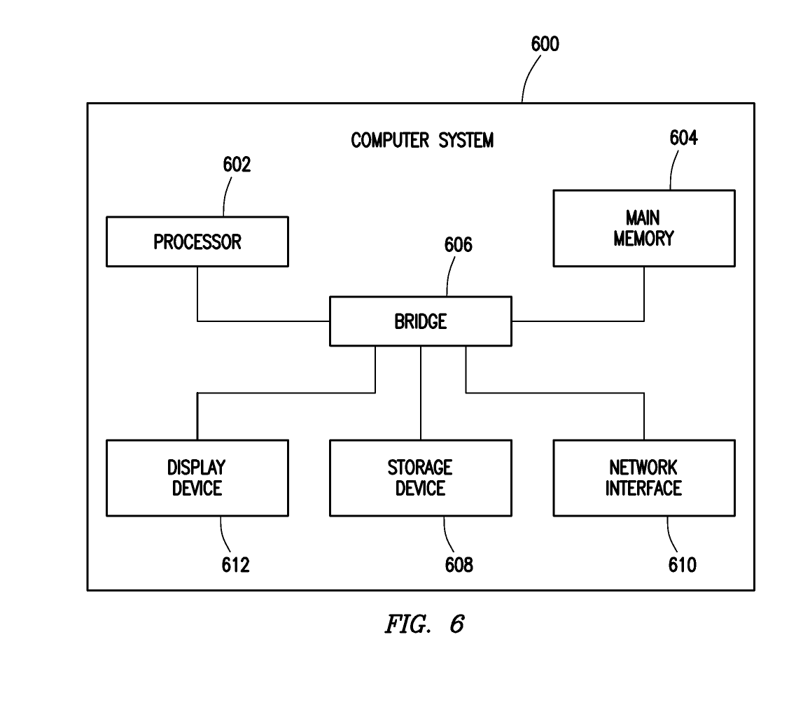

FIG. 6 shows a computer system 600, which is illustrative of a computer system upon which the various embodiments may be practiced. The computer system 600 may be illustrative of, for example, computer system 300 of the kiosk 100. In yet another embodiment, computer system 600 may be illustrative of the computer system of the portable electronic device 112. In yet still another embodiment, computer system 600 may be illustrative of computer system 310 at a service provider's remote location. In particular, computer system 600 comprises a processor 602, and the processor couples to a main memory 604 by way of a bridge device 606. Moreover, the processor 602 may couple to a long term storage device 608 (e.g., a hard drive, solid state disk, memory stick, optical disc) by way of the bridge device 606. Programs executable by the processor 602 may be stored on the storage device 608, and accessed when needed by the processor 602. The program stored on the storage device 608 may comprise programs to implement the various embodiments of the present specification, such as sending an indication to a service provider to purchase airtime. In some cases, the programs are copied from the storage device 608 to the main memory 604, and the programs are executed from the main memory 604. Thus, the main memory 604, and storage device 608 shall be considered computer-readable storage mediums. In addition, a display device 612, which may comprise any suitable electronic display device upon which any image or text can be displayed, may be coupled to the processor 602 by way of bridge 606. Furthermore, computer system 600 may comprise a network interface 610, coupled to the processor 602 by way of bridge 606, and coupled to storage device 606, the network interface acting to couple the computer system to a communication network.

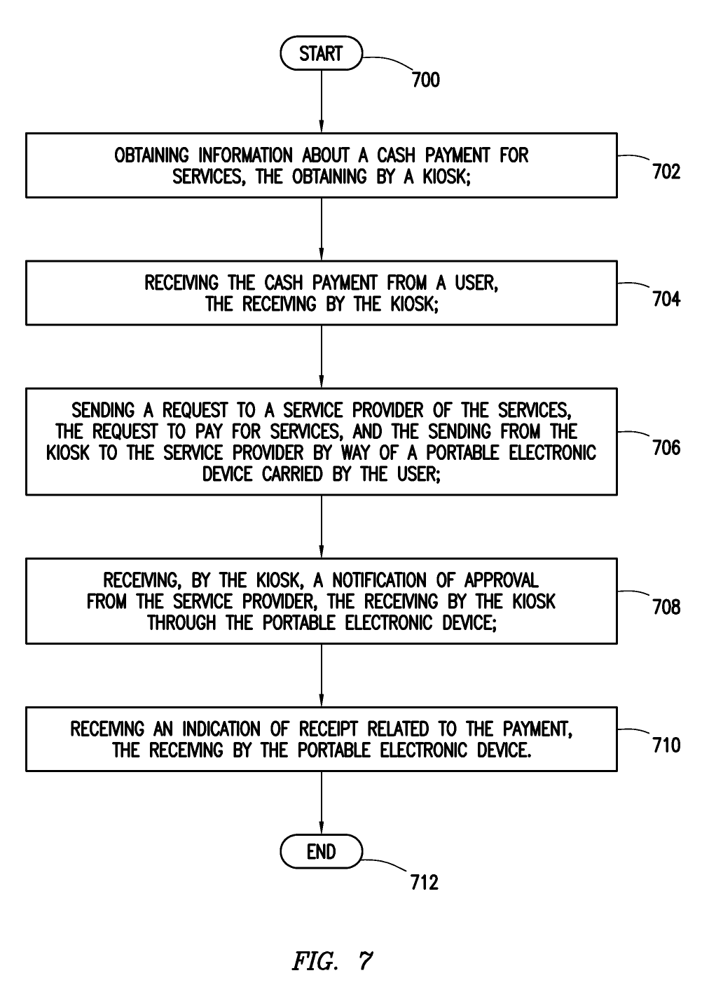

FIG. 7 shows, in flow diagram form, a method in accordance with some embodiments. The method starts (block 700) with obtaining information about a cash payment for services, the obtaining by a kiosk (block 702). The method then moves to receiving the cash payment from a user, the receiving by the kiosk (block 704); sending a request to a service provider of the services, the request to pay for services, and the sending from the kiosk to the service provider by way of a portable electronic device carried by the user (block 706); receiving, by the kiosk, a notification of approval from the service provider, the receiving by the kiosk through the portable electronic device (block 708); and receiving an indication of receipt related to the payment, the receiving by the portable electronic device (block 710). Thereafter, the method ends (block 712).

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments and/or to create a non-transitory computer-readable medium (i.e., not a carrier wave) that stores a software program to implement the method aspects of the various embodiments.

References to “one embodiment,” “an embodiment,” “some embodiments,” “various embodiments,” or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method comprising:
obtaining information about a cash payment for services, the obtaining by a kiosk;
receiving the cash payment from a user, the receiving by the kiosk;
sending a request to a service provider of the services, the request to pay for services, and the sending from the kiosk to the service provider by way of a portable electronic device carried by the user;
receiving, by the kiosk, a notification of approval from the service provider, the receiving by the kiosk through the portable electronic device; and
receiving an indication of receipt related to the payment, the receiving by the portable electronic device.

2. The method of claim 1 wherein obtaining information further comprises obtaining information from the user by way of at least one selected from the group consisting of: a touch-screen display device coupled to the kiosk; a keyboard coupled to the kiosk; and a keyboard coupled to the portable electronic device.

3. The method of claim 1 wherein obtaining information further comprises reading data from the portable electronic device, the reading by way of the wireless communication protocol.

4. The method of claim 1 wherein obtaining information further comprises receiving information by way of communication with an application executing on the portable electronic device.

5. The method of claim 1 wherein sending the request further comprises:
sending a message from the kiosk to the portable electronic device over a wireless communication protocol; and thereby
causing the portable electronic device to send the request to the service provider using a cellular service over a cellular network.

6. The method of claim 5 wherein causing the portable electronic device to send the request further comprises causing the portable electronic device to send the request over at least one selected from the group consisting of: a wireless voice channel; a wireless data message; or wireless text message service.

7. The method of claim 1 wherein receiving the notification of approval further comprises:
receiving a message from the service provider by the portable electronic device over a cellular service of a cellular network; and
forwarding the message by the portable electronic device to the to the kiosk, the forwarding over a wireless communication protocol.

8. The method of claim 1 wherein receiving the message from the service provider further comprises receiving over at least one selected from the group consisting of: a wireless voice channel; a wireless data message; or wireless text message service.

9. The method of claim 1 wherein receiving the cash payment further comprises receiving at least one selected from the group consisting of: banknotes; and coins.

10. The method of claim 1 further comprising triggering, by the kiosk, sending a receipt for the purchase of services by way of at least one selected from the group consisting of: a text message; and an electronic mail message.

11. A method comprising:
obtaining information about cash payment for cellular services, the obtaining by a kiosk;
receiving the cash payment from a user, the receiving by the kiosk;
sending a request to a cellular carrier, the request to pay for cellular services, and the sending from the kiosk to the cellular carrier by way of a portable electronic device carried by the user;
receiving, by the kiosk, a notification of approval from the cellular carrier, the receiving by the kiosk through the portable electronic device; and
receiving an indication of receipt related to the payment, the receiving by the portable electronic device.

12. The method of claim 11 wherein obtaining information further comprises obtaining information from the user by way of at least one selected from the group consisting of: a touch-screen display device coupled to the kiosk; and a keyboard coupled to the kiosk.

13. The method of claim 11 wherein obtaining information further comprises reading data from the portable electronic device of the user, the reading by way of a wireless communication protocol.

14. (canceled)

15. The method of claim 11 wherein obtaining information further comprises receiving information by way of communication with an application executing on the portable electronic device.

16. The method of claim 11 wherein sending the request further comprises:
sending a message from the kiosk to the portable electronic device over a wireless communication protocol; and thereby
causing the portable electronic device to send the request to the cellular carrier a cellular network.

17. The method of claim 16 wherein causing the portable electronic device to send the request further comprises causing the portable electronic device to send the request over at least one selected from the group consisting of: a wireless voice channel of the cellular network; a wireless data message of the cellular network; or wireless text message service of the cellular network.

18. The method of claim 11 wherein receiving the notification of approval further comprises:
receiving a message from the cellular carrier by the portable electronic device over a cellular network; and
forwarding the message by the portable electronic device to the to the kiosk, the forwarding over the wireless communication protocol.

19. The method of claim 18 wherein receiving the message from the service provider further comprises receiving over at least one selected from the group consisting of: a wireless voice channel of the cellular network; a wireless data message of the cellular network; or wireless text message service of the cellular network.

20. A kiosk comprising:
a processor;
a memory coupled to the processor; and
a wireless communication transceiver coupled to the processor;
the memory storing a program that, when executed by the processor, causes the processor to:
communicate with a portable electronic device by way of a wireless communication, wherein a range of the wireless communication is within a proximity surrounding the kiosk;
receive information about a cash payment for services, the receiving by way of reading data from the portable electronic device;
send a request to a service provider by way of the wireless communication with the portable electronic device; and
receive a notification of approval from the service provider, the receiving by way of communications with the portable electronic device.

21. The system of claim 20 wherein the program further causes the processor to trigger a sending of a receipt regarding the cash payment, the sending by way of at least one selected from the group consisting of: a text message; and an electronic mail message.

22. The system of claim 20 wherein the kiosk further comprises:
a display device visible on the kiosk;
an input device accessible on an outer surface of the kiosk;
wherein when the processor receives information, the program further causes the processor to receive information by way of the input device; and
wherein the program further causes the processor to display information on the display device.

23. The system of claim 22 wherein the display device is at least one selected from the group consisting of a computer monitor with touch-screen capabilities; and a computer monitor without touch-screen capabilities.

24. A non-transitory computer-readable medium storing a program that, when executed by a processor, causes the processor to:
receive information about a cash payment for services for a portable electronic device, the receiving by way of a wireless communication with the portable electronic device, wherein a range of the wireless communication is within a proximity of the processor;
send a request to a service provider by way of wireless communication with the portable electronic device; and
receive information regarding an indication of approval from the service provider by way of wireless communication with the portable electronic device.

25. The non-transitory computer-readable medium of claim 24 wherein when the processor receives information about the cash payment, the program further causes the processor to receive information by way of an input device.

26. A non-transitory computer-readable medium storing a program that, when executed by a processor of a portable electronic device, causes the processor to:
receive information from a user about a cash payment for services, the receiving on the portable electronic device;
send a request to a service provider of the services, the sending by way of a wireless communication, the sending by the portable electronic device; and
send a notification of approval from the service provider to a kiosk.

27. The non-transitory computer-readable medium of claim 26 where when the processor receives information, the program further causes the processor to receive by way of the wireless communication with the kiosk.

28. The non-transitory computer-readable medium of claim 26 where when the processor sends the request, the program further cases the processor to send the request to the service provider using a cellular service over a cellular network.

29. The non-transitory computer-readable medium of claim 26 where when the processor sends the request, the program further causes the processor to send the request over at least one selected from the group consisting of: a wireless voice channel; a wireless data message; or wireless text message service.

30. (canceled)
